(19) United States
(12) Patent Application Publication
(10) Pub. No.: US 2020/0076592 A1
(43) Pub. Date: Mar. 5, 2020

(54) METHOD FOR GENERATING SEED AND DEVICE THEREOF

(71) Applicant: Shanghai Ekool Information Technology Services Co. Ltd., Shanghai (CN)

(72) Inventor: Yanbin KONG, Shanghai (CN)

(73) Assignee: Shanghai Ekool Information Technology Service Co., Ltd., Shanghai (CN)

(21) Appl. No.: 16/190,451

(22) Filed: Nov. 14, 2018

(30) Foreign Application Priority Data
Sep. 4, 2018 (CN) 201811027003.9

(51) Int. Cl. H04L 9/08

(52) U.S. Cl. CPC H04L 9/0869; H04L 9/0894

(57) ABSTRACT

The present invention provides a method for generating a seed and a device thereof. The method includes: obtaining an algorithm key and generating a target seed algorithm sequence by the algorithm key and a seed algorithm group; obtaining inputted seed generation data; and finally inputting the seed generation data into the target seed algorithm sequence to generate a seed corresponding to the seed generation data. A target seed algorithm is generated by a seed selection algorithm, the algorithm key, calculation rounds and a target seed algorithm group are inputted into the seed selection algorithm, and the target seed algorithm adopted in the current calculation round is outputted. The target seed algorithm for all calculation rounds is combined into a target seed algorithm sequence. This invention increases the computational complexity of the third party through the seed generation data to collide the seed, thereby improving the security of the seed.

### CROSS REFERENCE TO RELATED APPLICATIONS

This application claims the benefit of CN2018110270039, filed on Sep. 4, 2018, the disclosure of which is incorporated herein by reference in its entirety.

### TECHNICAL FIELD

The present disclosure relates to the field of Internet technology and, more particularly, to a method for generating and recovering a seed and a device thereof.

### BACKGROUND

In the field of Internet technology, an asymmetric algorithm is used for a digital signature to ensure the integrity of transmitted information, to determine the identity authentication of sender, and to prevent the refusal in transaction from information and information-based. In this process, a public key of the asymmetric algorithm may be disclosed to the public, a private key must be kept by a user and must not be leaked and lost, therefore, it is so important for generating, backup and manage keys in security. The prior art in which may generate and recover the seed by seed generation data (a mnemonic word and a passphrase), and may generate a subkey for different proposes through the seed. For example, in the existing digital currency, BIP39 normatively has been used to generate and recover the seed by using a mnemonic word transcribed, when the software/hardware for saving the seed is damaged or lost, you can use the mnemonic word to recover the seed, the above specification in which also proposes to add passphrase and remember the passphrase in brain to avoid the seed leakage caused by mnemonic word stolen or peeped. However, the passphrase is selected by the user has a certain regularity, a third-party can use passphrase dictionary to collide the passphrase after obtaining the mnemonic word saved in plaintext. The existing high-performance computer, GPU and cloud computing have large collision throughout put up to million per second to make the passphrase collision achievable both on cost and time.

The statements in this section merely provide background information related to the present disclosure and may not constitute prior art.

### SUMMARY

The embodiment of the present disclosure provides a method for generating a seed and a device thereof. The seed generation by the target seed algorithm sequence can increase the computational complexity of the third party who wants to recover the seed through partial seed generation data, thereby improving the security of the seed.

The first aspect of the embodiment of the present disclosure provides a method for generating a seed, including the following steps. An algorithm key is obtained and the target seed algorithm sequence is generated by the algorithm key and a seed algorithm group; inputted seed generation data is obtained; and a seed corresponding to the seed generation data is generated by inputting the seed generation data into the target seed algorithm sequence.

The second aspect of the embodiment of the present disclosure provides a seed generating device. The device includes: a sequence generating module configured to obtain an algorithm key and generate a target seed algorithm sequence according to the algorithm key and a seed algorithm group; a data generation obtaining module configured to obtain inputted seed generation data; and a seed generating module configured to generate a seed corresponding to the seed generation data by inputting the seed generation data into the target seed algorithm sequence.

In the embodiments of the present disclosure, the algorithm key is obtained and the target seed algorithm sequence is generated by the algorithm key and the seed algorithm group; then the seed generation data is obtained; and finally, the seed corresponding to the seed generation data is generated by inputting the seed generation data into the target seed algorithm sequence. The seed is generated by the target seed algorithm sequence protected by the algorithm key, which increases the computational complexity of the third party generating data through partial seed and colliding the seed, thereby improving the security of the seed.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

FIG. 1 is a flowchart view of a method for generating a seed according to the embodiment of the present disclosure;

FIG. 2 is a flowchart view of another method for generating a seed according to the embodiment of the present disclosure;

FIG. 3 is a flowchart diagram of method for recovering a seed according the present disclosure;

FIG. 4 is a block diagram of a system for generating a seed according to the present disclosure;

FIG. 5 is a block diagram of another system for generating a seed according the present disclosure;

FIG. 6 is a block diagram of a device for generating a seed according to the embodiment of the present disclosure;

FIG. 7 is a block view of another device for generating a seed according to the present disclosure;

FIG. 8 is a block view of another device for generating a seed according to the present disclosure; and

FIG. 9 is a block view of another device for generating a seed according the present disclosure.

The drawings described herein are for illustrative purposes only of selected embodiments and not all possible implementations, and are not intended to limit the scope of the present disclosure. Corresponding reference numerals indicate corresponding parts throughout the several views of the drawings.

### DETAILED DESCRIPTION OF THE EMBODIMENTS

The following description of the preferred embodiments is merely exemplary in nature and is in no way intended to limit the invention, its application, or uses.

The embodiment of the present disclosure provides a method for generating a seed, which can be applied to an application scenario for ensuring the security of the seed in a digital asset security link. For example, a seed generating device can obtain an algorithm key, and can generate a target seed algorithm sequence through the algorithm key and a seed algorithm group, then, may obtain seed generation data, finally, may generate the seed corresponding to the seed generation data by inputting the seed generation data into the target seed algorithm sequence. Computational complexity of seed collision from a part of seed generation data by third-party increases by the target seed algorithm sequence protected by the algorithm key. Therefore, the security of the seed is improved.

The embodiment of this present disclosure relations to the seed generating device, which may be any terminal device which enables the code execution and data output and display, such as, microcontrollers, PLC, etc.

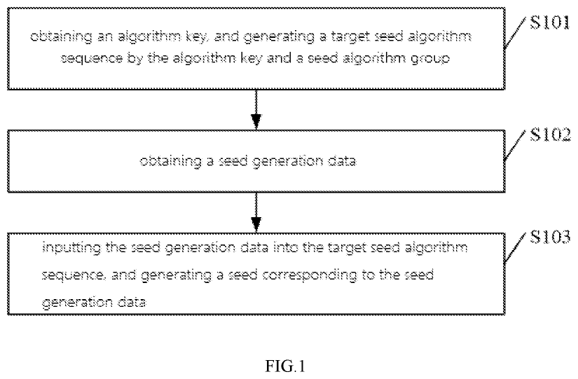

A method for generating the seed is provided by the embodiment of this present disclosure will be described in detail below referring to FIGS. 1-5.

FIG. 1 is a flowchart view of a method for generating a seed according to the embodiment of the present disclosure. As shown in FIG. 1, the embodiment of the present disclosure may include the following steps from S101 to S103.

Step 101, the algorithm key is obtained and the target seed algorithm sequence is generated by the algorithm key and the seed algorithm group.

The seed generating device can store the algorithm key on the basis of a control instruction of a host computer in a production phrase, which can be understood. For example, when the seed generating device receives an algorithm key save instruction, the algorithm key is given encrypted and signed according to the agreed algorithm, keys and method to verify and decrypt. The algorithm key is saved to a secure storage unit of a hardware after successful verification and decryption.

In particular, the seed generating device can obtain an algorithm key, and can generate a target seed algorithm sequence through the algorithm key and a seed algorithm group, which can be understood is, suppose there are two seed generation algorithms in the seed algorithm group, the seed generating device may select an algorithm (any one algorithm in the seed algorithm group) in any one step of a target algorithm sequence, therein, the number of the algorithms which can be selected in each step is the same as the number of the algorithms in the seed algorithm group. For example, the seed algorithm group has four seed generation algorithms, the target seed algorithm sequence consists of 1000 algorithm steps, there are four possibilities in each algorithm step, thereby, the entire algorithm sequence has 4¹⁰⁰⁰ combinations. Further, the seed generating device may generate the target seed algorithm sequence by the algorithm key and the seed algorithm group, and different algorithm keys generate different seed algorithm sequences. The target seed algorithm sequence which generates the seed has a large range of values and randomness, which can be understood.

Step 102, the seed generation data is obtained.

When the seed generating device gets a seed generation instruction, a random number can be generated and a mnemonic word through using a pre-made mnemonic word dictionary and a mnemonic word generation algorithm can be generated on the basis of the random number. And the mnemonic word can be showed to a user to transcribe and record by the user. And the correctness of the result transcribed can be ensured through the method for confirming by the user after transcribing by the user.

In particular, the seed generating device may obtain the seed generation data, the seed generation data may include the mnemonic word, and also can include a passphrase inputted by the user. The passphrase may be a passphrase set by the user according to on his own memory habits. In an embodiment, the seed generating device may ask the user to input the passphrase several times for ensure the right passphrase is inputted. In an embodiment, the seed generating device can verify the passphrase. For example, the user identity can be verified by PIN, then, the passphrase is obtained which inputted, compare the hash value of passphrase inputted with the hash value of the passphrase which stored when the seed is generated. When the both matches, a right verification result of the passphrase is indicated by output, otherwise, prompt information of a wrong verification is indicated by output.

Step 103, the seed corresponding to the seed generation data is generated by inputting the seed generation data into the target seed algorithm sequence.

In particular, the seed generating device may input the seed generation data into the target seed algorithm sequence to generate the seed corresponding to the seed generation data. The seed generation data also may include the mnemonic word and the passphrase. The seed generating device may be regarded the mnemonic word and the passphrase as an initial input of the target seed algorithm sequence, and after repeated iterations until the target algorithm sequence accomplishes the entire calculation process. For example, the target algorithm sequence may generate the seed after iterating 1000 times, which can be understood.

In this embodiment, even the seed algorithm group and a part of the seed generation data (such as, the mnemonic word) are known by the third-party. The third-party also need use the 4¹⁰⁰⁰ seed algorithm sequence possibilities for each possible passphrase to generate 4¹⁰⁰⁰ possible seeds. Each of these possible seeds must be used to generate public key of given path and compare with a known public key to determine collide result. The amount of calculation is greatly exceeded the calculation capability at present and the calculation capability within a period of time in future, let the passphrase collision be substantially impossible, which can be understood.

In the above-mentioned case, the third-party possible way is to input the mnemonic word and a guessed passphrase in the same algorithm key device saved. The possible seed is generated, then, the correctness of the seed is verified. This process must be accomplished by handcraft, and will be accomplished in at least several minutes sustained for every possible passphrase. In this case, as long as the user's mnemonic word seed has a certain passphrase strength, a workload which handcraft collided will be too large to accomplish.

In an embodiment, when the seed generating device receives a specific business instruction, a unit is generated by using a subkey. A corresponding key is generated to the seed, the corresponding calculation is accomplished according to a business requirement, and a business result will be returned to the host computer.

In an embodiment, the seed algorithm group may have a seed algorithm. The algorithm key can be regarded as the input of the target seed algorithm sequence with the seed generation data. The seed is generated by an iterative operation of an algorithm sequence. For example, when the length of the algorithm key is 512 bit, then in a given seed generation data which will bring 2⁵¹² possibilities. In the embodiment of the present disclosure, even the seed algorithm group and a part of the seed generation data (such as, the mnemonic word) are known by the third-party. The third-party also need use the 2⁵¹² possibilities of algorithm key and the entire seed generation data guessed to calculate for each the possible passphrase. These possible seeds which generated by 2⁵¹² and each of these possible seeds must be used to generate public key of given path and compare with a known public key to determine collide result. The amount of calculation is greatly exceeded the calculation capability at present and the calculation capability within a period of time in future, let the passphrase collision be substantially impossible. The algorithm key and a corresponding round are directly or after calculation converting regarded as one of the inputs of the target seed algorithms, which can transform the calculation result of the target seed algorithm sequence of the corresponding round, thereby, the seed generated is transformed. The anonymity of the seed is improved by adding dynamic changes to the seeds.

In the embodiment of the present disclosure, the algorithm key is obtained and the target seed algorithm sequence is generated by the algorithm key and the seed algorithm group; then the seed generation data is obtained; finally, the seed corresponding to the seed generation data by inputting the seed generation data into the target seed algorithm sequence is generated. Computational complexity of seed collision from a part of the seed generation data by third-party increases by the target seed algorithm sequence protected by the algorithm key, thereby, the security of the seed is improved.

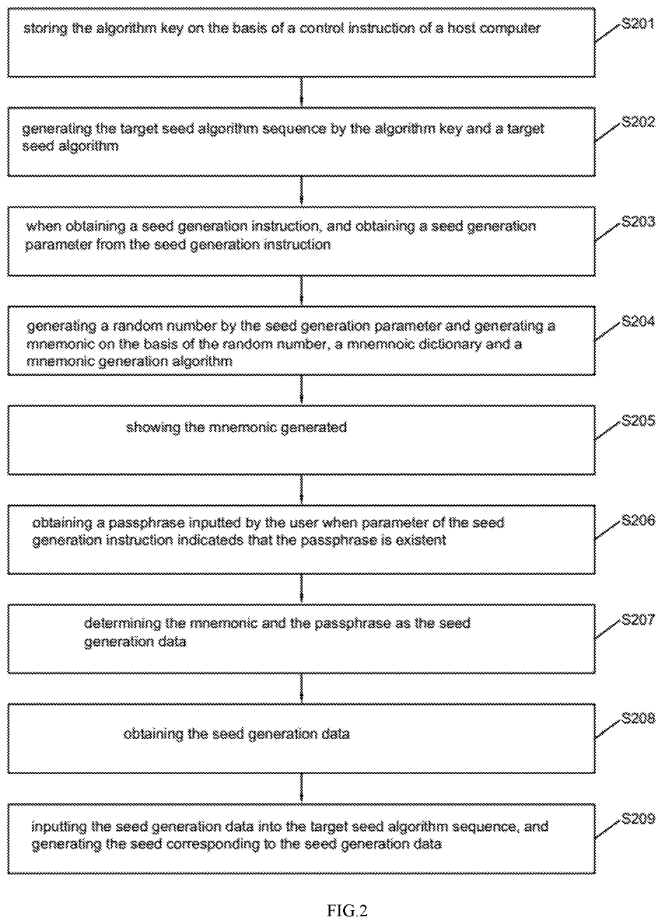

FIG. 2 is a flowchart view of another method for generating a seed according to the embodiment of the present disclosure. As shown in FIG. 2, the embodiment of the present disclosure may include the following steps from S201 to S209.

Step 201, the algorithm key is stored which on the basis of the control instruction of the host computer.

In particular, the seed generating device can store the algorithm key on the basis of the control instruction of the host computer in the production phrase, which can be understood. For example, when the seed generating device receives the instruction for keeping the algorithm key, the algorithm key is given encrypted and signed by the host computer according to the agreed algorithm and method to verify and decode. The algorithm key is saved to the secure storage unit of the hardware after successful verification.

Step 202, the target seed algorithm sequence is generated by the algorithm key and a target seed algorithm.

The target seed algorithm is a target seed algorithm which using a seed selection algorithm and being on the basis of a current calculation round selected in the seed algorithm group, which can be understood. The process selected can be accomplished before building a system or after building the system. A target seed algorithm group may include at least two target seed algorithms. The seed selection algorithm is a selection algorithm which selects the target seed algorithm. For example, the seed generating device can select an algorithm (any one algorithm in the seed algorithm group) in any one step of the target algorithm sequence, therein, the number of the algorithms which can be selected in each step is the same as the number of the algorithms in the seed algorithm group. For example, the seed algorithm group has four seed generation algorithms, the target seed algorithm sequence consists of 1000 algorithm steps, there are four possibilities in each algorithm step, thereby, the entire algorithm sequence has 4¹⁰⁰⁰ combinations. Further, the seed generating device may generate the target seed algorithm sequence by the algorithm key and the seed algorithm group, and different algorithm keys generate different seed algorithm sequences. The target seed algorithm sequence which generates the seed has a large range of values and randomness, which can be understood.

Step 203, when the seed generation instruction is obtained, then, a seed generation parameter is obtained from the seed generation instruction.

The seed generation parameter may include the number of the mnemonic word, whether the passphrase is contained, and how the passphrase is used in seed generating (such as, enhanced mode).

Step 204, the random number is generated by the seed generation parameter, and the mnemonic word is generated on the basis of the random number, a mnemonic word dictionary and the mnemonic word generation algorithm.

The seed generating device can generate the random number by the seed generation parameter and can generate the mnemonic word by using the pre-made mnemonic word dictionary and the mnemonic word generation algorithm on the basis of the random number.

Step 205, the mnemonic word generated is showed.

The mnemonic word can be showed to the user to transcribe and record by the user after the mnemonic word is generated by the seed generating device. And the correctness of the result transcribed can be ensured through the method for confirming by the user after transcribing by the user, which can be understood.

Step 206, the passphrase inputted by the user is obtained when parameter of a seed generation instruction parameter indicates that the passphrase is existent.

The passphrase may be a passphrase set by the user according to on his own memory habits, which can be understood. In an embodiment, the seed generating device may ask the user to input the passphrase several times for ensure the right passphrase is inputted. In an embodiment, the seed generating device can verify to the passphrase. For example, the user identity can be verified by PIN, then, the passphrase is obtained which inputted, compare the hash value of passphrase inputted with the hash value of the passphrase which stored when the seed is generated. When the both matches, the right verification result of the passphrase is indicated by output, otherwise, the prompt information of the wrong verification is indicated by output.

Step 207, the mnemonic word and the passphrase are determined as the seed generation data.

In particular, the seed generating device may determine the mnemonic word generated by itself, the passphrase inputted by the user and corresponding to the mnemonic word as the seed generation data.

Step 208, the seed generation data is obtained.

The seed generation data is recorded by the user. The seed generating device can obtain the seed generation data by the user, which can be understood. The seed generating device only need obtain the passphrase in the seed generation data when generate the seed, which can be understood.

Step 209, the seed corresponding to the seed generation data is generated by inputting the seed generation data into the target seed algorithm sequence.

In particular, the seed generating device may input the seed generation data into the target seed algorithm sequence to generate the seed corresponding to the seed generation data. The seed generation data also may include the mnemonic word and the passphrase. The seed generating device may be regarded the mnemonic word and the passphrase as an initial input of the target seed algorithm sequence, and after repeated iterations until the target algorithm sequence accomplishes the entire calculation process. For example, the target seed algorithm sequence may generate the seed after iterating 1000 times, which can be understood.

In this embodiment, even the seed algorithm group and a part of the seed generation data (such as, the mnemonic word) are known by the third-party. The third-party also need use the 4¹⁰⁰⁰ seed algorithm sequence possibilities for each possible passphrase to generate 4¹⁰⁰⁰ possible seeds. Each of these possible seeds must be used to generate public key of given path and compare with a known public key to determine collide result. The amount of calculation is greatly exceeded the calculation capability at present and the calculation capability within a period of time in future, let the passphrase collision be substantially impossible, which can be understood.

In the above-mentioned case, the third-party possible way is to input the mnemonic word and the guessed passphrase in the same algorithm key device saved. The possible seed is generated, then, the correctness of the seed is verified. This process must be accomplished by handcraft, and will be accomplished in at least several minutes sustained for every possible passphrase. In this case, as long as the user's mnemonic word seed has a certain passphrase strength, the workload which handcraft collided will be too large to accomplish.

In this embodiment, the seed is generated by the target seed algorithm sequence selected only, which ensures the uniqueness of the seed generation. Adding the amount of collision calculation when a part of the seed generation data is stolen or peeped, thereby, the difficulty of the seed stolen is added.

In an embodiment, when the seed generating device receives the specific business instruction, the unit is generated by using the subkey. The corresponding key is generated from the seed, the corresponding calculation is accomplished according to the business requirement, and the business result will be returned to the host computer.

In an embodiment, the seed algorithm group may have only one seed algorithm. The algorithm key can be regarded as the input of the target seed algorithm sequence with the seed generation data. The seed is generated by the iterative operation of the algorithm sequence. The algorithm key and the corresponding round are directly or after calculation converting regarded as one of the inputs of the target seed algorithms, which can transform the calculation result of the target seed algorithm sequence of the corresponding round, thereby, the seed generated is transformed. The anonymity of the seed is improved by adding dynamic changes to the seeds.

In the embodiment of the present disclosure, the algorithm key is obtained and the target seed algorithm sequence is generated by the algorithm key and the seed algorithm group; then the seed generation data is obtained; finally, the seed corresponding to the seed generation data by inputting the seed generation data into the target seed algorithm sequence is generated. Computational complexity of seed collision from a part of the seed generation data by third-party increases by the target seed algorithm sequence protected by the algorithm key, thereby, the security of the seed is improved. The seed is generated by the target seed algorithm sequence selected only, which ensures the uniqueness of the seed generation. Adding the amount of collision calculation when a part of the seed generation data is stolen or peeped, thereby, the difficulty of the seed stolen is added. The anonymity of the seed is improved by adding dynamic changes to the seeds.

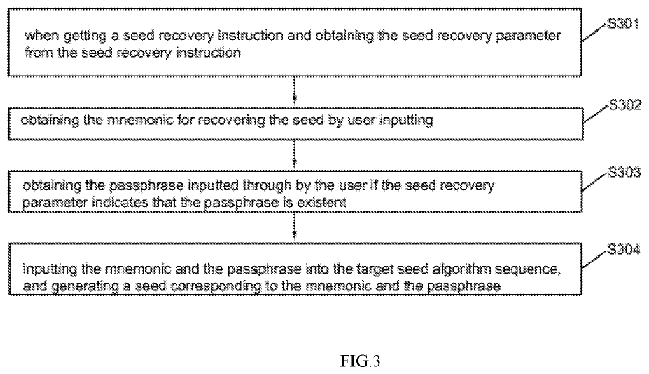

FIG. 3 is a flowchart diagram of method for recovering a seed according the present disclosure. As shown in FIG. 3, the embodiment of the present disclosure may include the following steps from 301 to 303.

Step 301, when a seed recovery instruction is gotten, the seed recovery parameter from the seed recovery instruction is obtained.

In particular, when the seed generating device gets the seed recovery instruction, the seed recovery parameter from the seed recovery instruction can be obtained. The seed recovery parameter may include the number of the mnemonic words, whether the passphrase is contained, and how the passphrase is used in seed generating (such as, enhanced mode).

Step 302, the mnemonic word for recovering the seed is obtained by user inputting.

In particular, the seed generating device obtain the mnemonic word according to seed recovery parameters (such as the number of mnemonic words) by user inputting.

Step 303, the passphrase inputted through the user is obtained if the seed recovery parameter indicates that the passphrase is existent.

In particular, the seed generating device may indicate the passphrase inputted by the user and corresponding to the mnemonic word by the seed recovery parameter. For example, according to whether the passphrase is contained, and how the passphrase is used in seed generating (such as, enhanced mode).

Step 304, the mnemonic word and the passphrase are inputted into the target seed algorithm sequence, and the seed is generated corresponding to the mnemonic word and the passphrase.

In particular, the seed generating device can input the mnemonic word and the passphrase into the target seed algorithm sequence, and can generate the seed corresponding to the mnemonic word and the passphrase. For example, the seed generating device may be regarded the mnemonic word and the passphrase as an initial input of the target seed algorithm sequence, and after repeated iterations until the target algorithm sequence accomplishes the entire calculation process. For example, the target seed algorithm sequence may recover the seed after iterating 1000 times.

In this embodiment, even the seed algorithm group and a part of the seed recovery data (such as, the mnemonic word) are known by the third-party. The third-party also need use the 4¹⁰⁰⁰ seed algorithm sequence possibilities for each possible passphrase to generate 4¹⁰⁰⁰ possible seeds. Each of these possible seeds must be used to generate public key of given path and compare with a known public key to determine collide result. The amount of calculation is greatly exceeded the calculation capability at present and the calculation capability within a period of time in future, let the passphrase collision be substantially impossible, which can be understood.

In the above-mentioned case, the third-party possible way is to input the mnemonic word and the guessed passphrase in the same algorithm key device saved. The possible seed is generated, then, the correctness of the seed is verified. This process must be accomplished by handcraft, and will be accomplished in at least several minutes sustained for every possible passphrase. In this case, as long as the user's mnemonic word seed has a certain passphrase strength, the workload which handcraft collided will be too large to accomplish.

In this embodiment, the seed is generated by the target seed algorithm sequence selected only, which ensures the uniqueness of the seed generation. Adding the amount of collision calculation when a part of the seed generation data is stolen or peeped, thereby, the difficulty of the seed stolen is added.

In the embodiment of the present disclosure, the algorithm key is obtained and the target seed algorithm sequence is generated by the algorithm key and the seed algorithm group; then the seed generation data is obtained; finally, the seed corresponding to the seed generation data by inputting the seed generation data into the target seed algorithm sequence is generated. Computational complexity of seed collision from a part of the seed generation data by third-party increases by the target seed algorithm sequence protected by the algorithm key, thereby, the security of the seed is improved. The seed is generated by the target seed algorithm sequence selected only, which ensures the uniqueness of the seed generation. Adding the amount of collision calculation when a part of the seed generation data is stolen or peeped, thereby, the difficulty of the seed stolen is added.

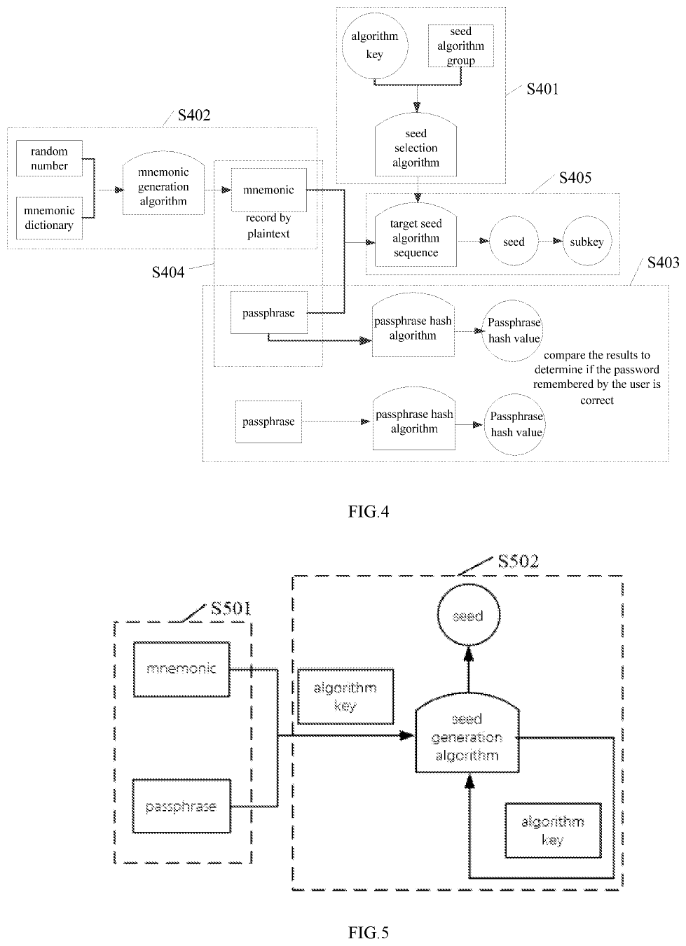

A specific manner of this embodiment, the seed algorithm group includes at least two seed algorithms. The embodiment of the present disclosure may include the following steps as shown in FIG. 4.

Step 401, the target seed algorithm sequence is generated.

In particular, the target seed algorithm sequence is generated in step 401 and step 402, and the process of the mnemonic word can refer to the detailed description in the above method embodiment, and details will not be described herein again.

Step 402, the mnemonic word is generated.

Step 403, the passphrase is verified.

In particular, the seed generating device can verify the passphrase inputted by the user. For example, when the user input the passphrase, the seed generating device can use a hash algorithm of the passphrase to calculate the passphrase hash value of the passphrase, and the passphrase hash value is matched with the passphrase hash value saved when generating current seed. When the both matches, the passphrase inputted by the user which can be regarded is right. Otherwise, the passphrase inputted by the user which can be regarded is wrong. Therein, the passphrase hash value verified is a hash value which can be used to test quickly the correctness of the passphrase.

Step 404, the seed generation data is obtained.

Step 405, the seed is generated.

In particular, the seed generating device can generate the process of the seed by the seed generation data and the target seed algorithm sequence which can refer to the detailed description in the above method embodiment, and details will be not described herein again.

In the embodiment of the present disclosure, the algorithm key is obtained and the target seed algorithm sequence is generated by the algorithm key and the seed algorithm group; then the seed generation data is obtained; finally, the seed corresponding to the seed generation data by inputting the seed generation data into the target seed algorithm sequence is generated. Computational complexity of seed collision from a part of the seed generation data by third-party increases by the target seed algorithm sequence protected by the algorithm key, thereby, the security of the seed is improved. The seed is generated by the target seed algorithm sequence selected only, which ensures the uniqueness of the seed generation. Adding the amount of collision calculation when a part of the seed generation data is stolen or peeped, thereby, the difficulty of the seed stolen is added.

A specific manner of this embodiment, the seed algorithm group has only one seed algorithm. The embodiment of the present disclosure may include the following steps as shown in FIG. 5.

Step 501, the seed generation data is obtained.

In particular, the seed generating device obtains the process of the seed generation data, which can refer to the detailed description in the above method embodiment, and details will be not described herein again.

Step 502, the seed is generated.

The seed algorithm group has only one seed algorithm. In this case the target algorithm sequence is fixed. The algorithm key adds to the seed generation data and the calculation output of the previous round target seed algorithm calculation as input of the next round target seed algorithm in each iterations. The joining of the algorithm key will add the randomness of the seed generation. When the length of the algorithm key is 512 bits, then, the possibilities with 2⁵¹² will be brought in the certain seed generation data, which can be understood.

In the embodiment of the present disclosure, even the seed algorithm group and a part of the seed generation data (such as, the mnemonic word) are known by the third-party. The third-party also need use the 2⁵¹² possibilities of algorithm key and the entire seed generation data guessed to calculate for each the possible passphrase. These possible seeds which generated by 2⁵¹² and each of these possible seeds must be used to generate public key of given path and compare with a known public key to determine collide result. The amount of calculation is greatly exceeded the calculation capability at present and the calculation capability within a period of time in future, let the passphrase collision be substantially impossible.

In the above-mentioned case, the third-party possible way is to input the mnemonic word and a guessed passphrase in the same algorithm key device saved. The possible seed is generated, then, the correctness of the seed is verified. This process must be accomplished by handcraft, and will be accomplished in at least several minutes sustained for every possible passphrase. In this case, as long as the user's mnemonic word seed has a certain passphrase strength, a workload which handcraft collided will be too large to accomplish.

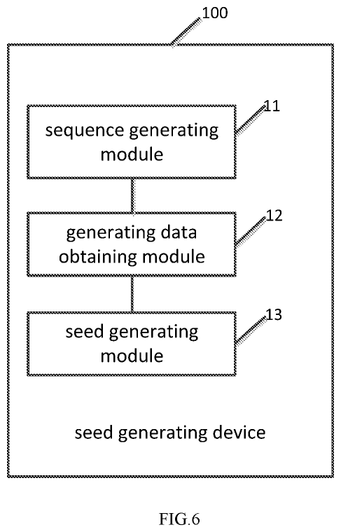

A seed generating device will be described in detail, which provided by the embodiment of this present disclosure will be described in below referring to FIGS. 6-8. The seed generating device is indicated by FIGS. 6-8, which will be used to execute the method of the embodiment of the present disclosure indicated by FIGS. 1-5. For the convenience of the description, a corresponding part is only showed to the present disclosure. Please refer to the embodiment indicated by FIGS. 1-5, because of the specific technology details not disclosed.

FIG. 6 is a block diagram of a seed generating device 100 according to the embodiment of the present disclosure. As shown in FIG. 6, the seed generating device 100 also may include: a sequence generating module 11, a data generation obtaining module 12 and a seed generating module 13.

The sequence obtaining module 11 is configured to obtain an algorithm key, and to generate a target seed algorithm sequence by the algorithm key and a seed algorithm group.

The seed generating device 100 can store the algorithm key on the basis of a control instruction of a host computer in a production phrase. For example, when the seed generating device 100 receives the instruction of the algorithm key saved, the algorithm key is given encrypted and signed by the host computer according to the agreed algorithm and method to verify and decode. The algorithm key is saved to a secure storage unit of a hardware after successful verification.

In an embodiment, the sequence generating module 11 can obtain the algorithm key, and can generate the target seed algorithm sequence by the algorithm key and the seed algorithm group. The seed algorithm group has at least two seed generation algorithms. The seed generating device 100 can select an algorithm (any one algorithm in the seed algorithm group) in any one step of the target algorithm sequence, therein, the number of the algorithms which can be selected in each step is the same as the number of the algorithms in the seed algorithm group. For example, the seed algorithm group has four seed generation algorithms, the target seed algorithm sequence consists of 1000 algorithm steps, there are four possibilities in each algorithm step, thereby, the entire algorithm sequence has 4¹⁰⁰⁰ combinations. Further, the seed generating device 100 may generate the target seed algorithm sequence by the algorithm key and the seed algorithm group, and different algorithm keys generate different seed algorithm sequences. The target seed algorithm sequence which generates the seed has a large range of values and randomness, which can be understood.

The data generation obtaining module 12 is configured to obtain seed generation data.

When the seed generating device 100 gets a seed generation instruction, which can output a random number and can generate a mnemonic word by using a pre-made mnemonic word dictionary and a mnemonic word generation algorithm on the basis of the random number. The mnemonic word can be showed to the user to transcribe and record by the user. And the correctness of the result transcribed can be ensured through the method for confirming by a user after transcribing by the user, which can be understood.

In an embodiment, the data generation obtaining module 12 can obtain the seed generation data. The seed generation data can include the mnemonic word and also can include the passphrase inputted by the user. The passphrase may be a passphrase set by the user according to on his own memory habits, which can be understood. In an embodiment, the seed generating device 100 may ask the user to input the passphrase several times for ensure the right passphrase is inputted. In an embodiment, the seed generating device 100 can verify the passphrase. For example, the user identity can be verified by PIN, then, the passphrase is obtained which inputted, compare the hash value of passphrase inputted with the hash value of the passphrase which stored when the seed is generated. When the both matches, the right verification result of the passphrase is indicated by output, otherwise, the prompt information of the wrong verification is indicated by output.

The seed generating module 13 is configured to input the seed generation data into the target seed algorithm sequence, and to generate a seed corresponding to the seed generation data.

In an embodiment, the seed generating module 13 can input the seed generation data into the target seed algorithm sequence, and can generate the corresponding seed to the seed generation data. The seed generation data may include the mnemonic word and the corresponding passphrase to the mnemonic word. The seed generating module 13 can be regarded the mnemonic word and the passphrase as the initial input of the target seed algorithm sequence, and after repeated iterations until the target algorithm sequence accomplishes the entire calculation process. For example, the target seed algorithm sequence may recover the seed after iterating 1000 times, which can be understood.

In this embodiment, even the seed algorithm group and a part of the seed recovery data (such as, the mnemonic word) are known by the third-party. The third-party also need use the 4¹⁰⁰⁰ seed algorithm sequence possibilities for each possible passphrase to generate 4¹⁰⁰⁰ possible seeds. Each of these possible seeds must be used to generate public key of given path and compare with a known public key to determine collide result. The amount of calculation is greatly exceeded the calculation capability at present and the calculation capability within a period of time in future, let the passphrase collision be substantially impossible, which can be understood.

In the above-mentioned case, the third-party possible way is to input the mnemonic word and the guessed passphrase in the same algorithm key device saved. The possible seed is generated, then, the correctness of the seed is verified. This process must be accomplished by handcraft, and will be accomplished in at least several minutes sustained for every possible passphrase. In this case, as long as the user's mnemonic word seed has a certain passphrase strength, the workload which handcraft collided will be too large to accomplish.

In an embodiment, when the seed generating device 100 receives the specific business instruction, the unit is generated by using the subkey. The corresponding key is generated from the seed, the corresponding calculation is accomplished according to the business requirement, and the business result will be returned to the host computer.

In an embodiment, the seed algorithm group may have only a seed algorithm. The algorithm key can be regarded as the input of the target seed algorithm sequence with the seed generation data. The seed is generated by the iterative operation of the algorithm sequence. For example, when the length of the algorithm key is 512 bit. In the embodiment of the present disclosure, even the seed algorithm group and a part of the seed generation data (such as, the mnemonic word) are known by the third-party. The third-party also need use the 2⁵¹² possibilities of algorithm key and the entire seed generation data guessed to calculate for each the possible passphrase. These possible seeds which generated by 2⁵¹² and each of these possible seeds must be used to generate public key of given path and compare with a known public key to determine collide result. The amount of calculation is greatly exceeded the calculation capability at present and the calculation capability within a period of time in future, let the passphrase collision be substantially impossible. The algorithm key and a corresponding round are directly or after calculation converting regarded as one of the inputs of the target seed algorithms, which can transform the calculation result of the target seed algorithm sequence of the corresponding round, thereby, the seed generated is transformed. The anonymity of the seed is improved by adding dynamic changes to the seeds.

In the embodiment of the present disclosure, the algorithm key is obtained and the target seed algorithm sequence is generated by the algorithm key and the seed algorithm group; then the seed generation data is obtained; finally, the seed corresponding to the seed generation data by inputting the seed generation data into the target seed algorithm sequence is generated. Computational complexity of seed collision from a part of the seed generation data by third-party increases by the target seed algorithm sequence protected by the algorithm key, thereby, the security of the seed is improved. The anonymity of the seed is improved by adding dynamic changes to the seeds.

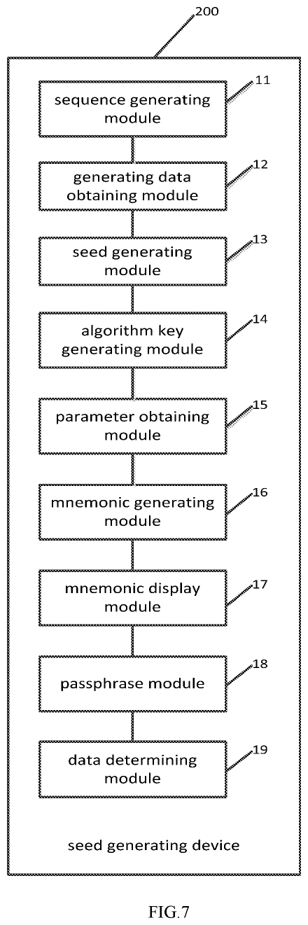

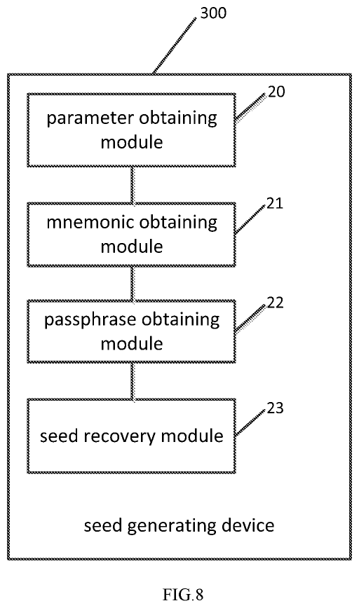

FIG. 7 is a block view of another device for generating a seed according to the present disclosure. As shown in FIG. 7, the seed generating device 200 may include: a sequence generating module 11, a data generation obtaining module 12, a seed generating module 13, an algorithm key generating module 14, a parameter obtaining module 15, a mnemonic word generating module 16, a mnemonic word display module 17, a passphrase obtaining module 18 and a data determining module 19.

The algorithm key generating module 14 is configured to store the algorithm key on the basis of the control instruction of the host computer.

In an embodiment, the algorithm key generating module can generate and store the algorithm key on the basis of the control instruction of the host computer in the production phrase. For example, when the algorithm key generating module 14 receives the instruction of the algorithm key saved, the algorithm key is given encrypted and signed by the host computer according to the agreed algorithm and method to verify and decode. The algorithm key is saved to the secure storage unit of a hardware after successful verification.

The sequence generating module 11 is particularly configured to generate the target seed algorithm sequence by the algorithm key and the target seed algorithm.

The seed selection algorithm is an algorithm which using the algorithm key select one algorithm from target seed algorithm group for each seed generating iterations, which can be understood. The process selected can be accomplished before building the system or after building the system. The target seed algorithm group may include at least two target seed algorithms. The seed selection algorithm is the selection algorithm which selects the target seed algorithm. For example, the sequence generating module 11 may select the algorithm (any one algorithm in the seed algorithm group) in any one step of the target algorithm sequence, therein, the number of the algorithm which can be selected in each step is the same as the number of the algorithm in the seed algorithm group. For example, the seed algorithm group has four seed generation algorithms, the target seed algorithm sequence consists of 1000 algorithm steps, and there are four possibilities in each algorithm step, thereby, the entire algorithm sequence has 4¹⁰⁰⁰ combinations. Further, the seed generating device 200 may generate the target seed algorithm sequence by the algorithm key and the seed algorithm group, and different algorithm keys generate different seed algorithm sequences. The target seed algorithm sequence which generates the seed has a large range of values and randomness, which can be understood.

The parameter obtaining module 15 is configured to obtain the seed generation parameter from the seed generation instruction or the seed recovery instruction when gets the seed generation instruction and the seed recovery instruction.

The seed generation parameter may include the number of the mnemonic word. Whether the passphrase is contained. Whether the parameters (such as, enhance mode) are used, which can be understood.

The mnemonic word generating module 16 is configured to generate a random number by the seed generation parameter and to generate the mnemonic word on the basis of the random number, the mnemonic word dictionary and the mnemonic word generation algorithm.

The mnemonic word generating module 16 may generate the random number by the seed generation parameter and may generate the mnemonic word by using the pre-made mnemonic word dictionary and the mnemonic word generation algorithm on the basis of the random number.

The mnemonic word display module 17 is configured to show the mnemonic word generated.

The mnemonic word display module 17 may show the mnemonic word to the user after the mnemonic word generating module 16 generates the mnemonic word to transcribe and record by the user. And the correctness of the result transcribed can be ensured through the method for confirming by the user after transcribing by the user, which can be understood.

The passphrase obtaining module 18 is configured to obtain the passphrase inputted by the user.

In an embodiment, the passphrase obtaining module 18 can obtain the passphrase inputted by the user. The passphrase may be a passphrase set by the user according to on his own memory habits, which can be understood. In an embodiment, the passphrase obtaining module 18 may ask the user to input the passphrase several times for ensure the right passphrase is inputted. In an embodiment, the mnemonic word obtaining module 18 can verify to the passphrase. For example, the user identity can be verified by PIN, then, the passphrase is obtained which inputted, compare the hash value of passphrase inputted with the hash value of the passphrase which stored when the seed is generated. When the both matches, the right verification result of the passphrase is indicated by output, otherwise, the prompt information of the wrong verification is indicated by output.

The data determining module 19 is configured to determine the mnemonic word and the passphrase as seed generation data.

In an embodiment, the data determining module 19 may determine the mnemonic word generated by itself, the passphrase inputted by the user and corresponding to the mnemonic word as the seed generation data.

The data generation obtaining module 12 is configured to obtain the seed generation data.

The seed generation data is recorded by the user. The data generation obtaining module 12 may obtain the seed generation data by the user, which can be understood. The data generation obtaining module 12 only need obtain the passphrase in the seed generation data, which can be understood.

The seed generating module 13 is configured to input the seed generation data into the target seed algorithm sequence, then, to generate the corresponding seed to the seed generation data.

In an embodiment, the seed generation module 13 may input the seed generation data into the target seed algorithm sequence, then, to generate the corresponding seed to the seed generation data. The seed generation data can include the mnemonic word and the corresponding passphrase to the mnemonic word. The seed generating module 13 can be regarded the mnemonic word and the passphrase as the initial input of the target seed algorithm, and after repeated iterations until the target algorithm sequence accomplishes the entire calculation process. For example, the target algorithm sequence may recover the seed after iterating 1000 times, which can be understood.

In this embodiment, even the seed algorithm group and a part of the seed generation data (such as, the mnemonic word) are known by the third-party. The third-party also need use the 4¹⁰⁰⁰ seed algorithm sequence possibilities on each possible passphrase to generate 4¹⁰⁰⁰ possible seeds. Each of these possible seeds must be used to generate public key of given path and compare with a known public key to determine collide result. The amount of calculation is greatly exceeded the calculation capability at present and the calculation capability within a period of time in future, let the passphrase collision be substantially impossible, which can be understood.

In the above-mentioned case, the third-party possible way is to input the mnemonic word and the guessed passphrase in the same algorithm key device saved. The possible seed is generated, then, the correctness of the seed is verified. This process must be accomplished by handcraft, and will be accomplished in at least several minutes sustained for every possible passphrase. In this case, as long as the user's mnemonic word seed has a certain passphrase strength, the workload which handcraft collided will be too large to accomplish.

In this embodiment, the seed is generated by the target seed algorithm sequence selected only, which ensures the uniqueness of the seed generation. Adding the amount of collision calculation when a part of the seed generation data is stolen or peeped, thereby, the difficulty of the seed stolen is added.

In an embodiment, when the seed generating device 200 receives the specific business instruction, the unit is generated by using the subkey. The corresponding key is generated from the seed, the corresponding calculation is accomplished according to the business requirement, and the business result will be returned to the host computer.

In an embodiment, the seed algorithm group may have only one seed algorithm. The algorithm key can be regarded as the input of the target seed algorithm sequence with the seed generation data. The seed is generated by the iterative operation of the algorithm sequence. The algorithm key and the corresponding round are directly or after calculation converting regarded as one of the inputs of the target seed algorithms, which can transform the calculation result of the target seed algorithm sequence of the corresponding round, thereby, the seed generated is transformed. The anonymity of the seed is improved by adding dynamic changes to the seeds.

In the embodiment of the present disclosure, the algorithm key is obtained and the target seed algorithm sequence is generated by the algorithm key and the seed algorithm group; then the seed generation data is obtained; finally, the seed corresponding to the seed generation data by inputting the seed generation data into the target seed algorithm sequence is generated. Computational complexity of seed collision from a part of the seed generation data by third-party increases by the target seed algorithm sequence protected by the algorithm key, thereby, the security of the seed is improved. The seed is generated by the target seed algorithm sequence selected only, which ensures the uniqueness of the seed generation. Adding the amount of collision calculation when a part of the seed generation data is stolen or peeped, thereby, the difficulty of the seed stolen is added. The anonymity of the seed is improved by adding dynamic changes to the seeds.

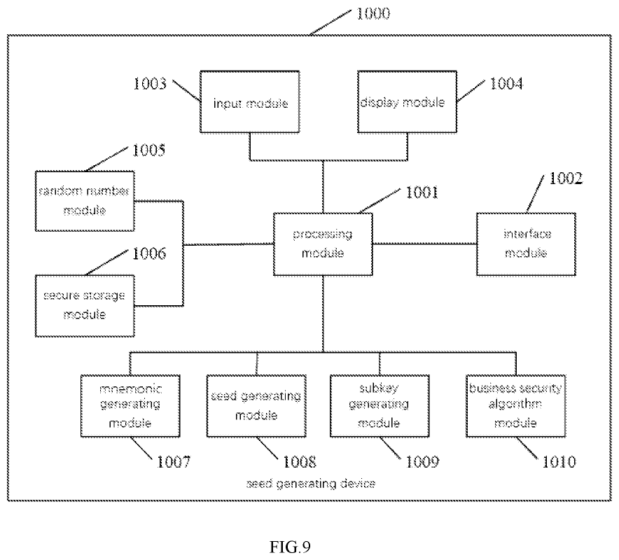

FIG. 8 is a block view of another device for generating a seed according to the present disclosure. As shown in FIG. 8, the seed generating device 300 may include: a parameter obtaining module 20, a mnemonic word obtaining module 21, a passphrase obtaining module 22 and a seed recovery module 23.

The parameter obtaining module 20 is configured to obtain—the seed recovery parameter from the seed recovery instruction when gets—the seed recovery instruction.

In an embodiment, when the parameter obtaining module 20 gets the seed recovery instruction, then, can obtain the seed recovery parameter from the seed recovery instruction. The seed recovery parameter can include the number of the mnemonic words. Whether the passphrase is contained. Whether the parameters (such as, enhance mode) are used, which can be understood.

The mnemonic word obtaining module 21 is configured to obtain the mnemonic word for recovering the seed by the seed recovery parameter.

In an embodiment, the mnemonic word obtaining module 21 can obtain the mnemonic word for recovering the seed according to seed recovery parameters (such as, the number of the mnemonic words).

The passphrase obtaining module 22 is configured to obtain the passphrase inputted by the user by the seed recovery parameter.

In particular, the passphrase obtaining module 22 can indicate the passphrase inputted by the user and corresponding to the mnemonic word by the seed recovery parameter. For example, according to whether the passphrase is contained, and how the passphrase is used in seed generating (such as, enhanced mode).

The seed recovery module 23 is configured to input the mnemonic word and the passphrase into the target seed algorithm sequence, to generate the seed corresponding to the mnemonic word and the passphrase.

In an embodiment, the seed recovery module 23 can input the mnemonic word and the passphrase into the target seed algorithm sequence, and can generate the seed corresponding to the mnemonic word and the passphrase. For example, the seed recovery module 23 can be regarded the mnemonic word and the passphrase as the initial input of the target seed algorithm, and after repeated iterations until the target algorithm sequence accomplishes the entire calculation process. For example, the target algorithm sequence may recover the seed after iterating 1000 times, which can be understood.

In this embodiment, even the seed algorithm group and a part of the seed generation data (such as, the mnemonic word) are known by the third-party. The third-party also need use the 4¹⁰⁰⁰ seed algorithm sequence possibilities on each possible passphrase to generate 4¹⁰⁰⁰ possible seeds. Each of these possible seeds must be used to generate public key of given path and compare with a known public key to determine collide result. The amount of calculation is greatly exceeded the calculation capability at present and the calculation capability within a period of time in future, let the passphrase collision be substantially impossible, which can be understood.

In the above-mentioned case, the third-party possible way is to input the mnemonic word and the guessed passphrase in the same algorithm key device saved. The possible seed is generated, then, the correctness of the seed is verified. This process must be accomplished by handcraft, and will be accomplished in at least several minutes sustained for every possible passphrase. In this case, as long as the user's mnemonic word seed has a certain passphrase strength, the workload which handcraft collided will be too large to accomplish.

In this embodiment, the seed is generated by the target seed algorithm sequence selected only, which ensures the uniqueness of the seed generation. Adding the amount of collision calculation when a part of the seed generation data is stolen or peeped, thereby, the difficulty of the seed stolen is added.

In the embodiment of the present disclosure, the algorithm key is obtained and the target seed algorithm sequence is generated by the algorithm key and the seed algorithm group; then the seed generation data is obtained; finally, the seed corresponding to the seed generation data by inputting the seed generation data into the target seed algorithm sequence is generated. Computational complexity of seed collision from a part of the seed generation data by third-party increases by the target seed algorithm sequence protected by the algorithm key, thereby, the security of the seed is improved. The seed is generated by the target seed algorithm sequence selected only, which ensures the uniqueness of the seed generation. Adding the amount of collision calculation when a part of the seed generation data is stolen or peeped, thereby, the difficulty of the seed stolen is added.

FIG. 9 is a block view of another device for generating a seed according the present disclosure. As shown in FIG. 9, the seed generating device 1000 may include: at least a processing module 1001, an interface module 1002, an input module 1003, a display module 1004, a random number module 1005, a secure storage module 1006, a mnemonic word generating module 1007, a seed generating module 1008, a subkey generating module 1009, a business security algorithm module 1010.

Therein, the processing module 1001 includes a CPU, a RAM/ROM and a corresponding bus system. The processing module 1001 executes a software code and calls the corresponding module to accomplish the corresponding function, then, a host computer is alternated with a user that can be implemented.

The interface module 1002 can be a standard wired interface or a wireless interface (such as, USB, Bluetooth, WI-FI interface), which is configured to dock with the host computer, to receive an instruction from the host computer sent, and to send an instruction execution result to the host computer.

The input module 1003 may accomplish the modules (such as, the mnemonic word, the passphrase, a PIN code, etc.) which a security sensitive information inputted, and avoid the risk that an input to be intercepted on the host computer with a lower security level, which may be a touched input or a keyboard input. The user also can accomplish the input of the above data in the host computer, which can be understood.

The display module 1004 can accomplish an alternated module by the display module which shows an information and a user. The information (such as, the mnemonic word, business information, etc.) is shown directly on the hardware instead of returning the host computer that can be reduced a telltale or temper risk.

The random number module 1005 can be configured to generate a random number, which generate the mnemonic word, etc.

The secure storage module 1006 can be configured to store the algorithm key, the seed, and the modules relate to a necessary security data.

The mnemonic word generating module 1007 can include a pre-made mnemonic word dictionary, and can generate mnemonic word with a mnemonic word algorithm and a given specification random number.

The seed generating module 1008 can include a group of a seed generation algorithm. An algorithm of a current round seed generation algorithm is selected by a calculation round and the algorithm key. The input of the module includes the mnemonic word, the passphrase, the algorithm key, and the final output is the seed corresponding to the seed generation data.

The subkey generating module 1009 conforms to the standard BIP32. The subkey which has different levels like a tree is generated by the seed. In this case, a corresponding subkey can be gotten by a given index.

The business security algorithm module 1010, which can be understood is, a security algorithm from a variety of specific business (used to query, transact, sign, and sign verified a digital currency, etc.) will be determined by a corresponding business.

In the embodiment of the present disclosure, the algorithm key is obtained and the target seed algorithm sequence is generated by the algorithm key and the seed algorithm group; then the seed generation data is obtained; finally, the seed corresponding to the seed generation data by inputting the seed generation data into the target seed algorithm sequence is generated. Computational complexity of seed collision from a part of the seed generation data by third-party increases by the target seed algorithm sequence protected by the algorithm key, thereby, the security of the seed is improved. The seed is generated by the target seed algorithm sequence selected only, which ensures the uniqueness of the seed generation. Adding the amount of collision calculation when a part of the seed generation data is stolen or peeped, thereby, the difficulty of the seed stolen is added.

For the above various method embodiments, to description simple, which will be described as a series of action combinations. However, the technologists in the art should know that the present disclosure is not limited by the order of action described. Because certain steps may use in the other orders or concurrently in accordance with the present invention. Secondly, the technologists in the art should also know that the embodiments described in the instructions all belong to the preferred embodiments, and which relates to the actions and modules are not necessarily required by the present disclosure, which should be noted.

In a few of embodiments provided by the present disclosure, the device disclosed can be implemented by the other ways, which can be understood. For example, the above device embodiments described is just schematic. For example, the division of the above units is just a logical function division, and there may be another division way in actual implement. For example, multiple units or components may be combined or integrated into another system, or some features can be ignored or be not executed. In addition, the connections or couplings shown or discussed may indirectly couple or connect the communication through some interfaces, devices or units, and may be electrical or otherwise, and may be not limited to directly connect through wires.

The units described above as separate components may or may not be physically separated, and as the components of units displayed may or may not be physical units, which is, may be located in one place, or may be distributed to multiple network units. Some or all of the units may be selected according to actual needs to achieve the purpose of the solution of the embodiment.

In addition, each functional unit in each embodiment of the present disclosure may be integrated into one processing unit, or may be each unit which existed by separate physical, or two or more units may be integrated into one unit. The above integrated unit can be implemented in the form of hardware or in the form of a software functional unit.

The ordinary technologists can understand that implement the entire or partial steps in the method of the above embodiments, which can accomplish by the corresponding hardware which be instructed in a computer program. The program can be stored in a computer-readable stored medium. When the program is executed which can include the step of the embodiment of the above each method. Therein, the stored medium can be a floppy disk, an optical disc, Read-Only Memory (ROM), FLASH, NAND FLASH, or Random Access Memory (RAM).

The above illustrates and describes basic principles, main features and advantages of the present invention. Those skilled in the art should appreciate that the above embodiments do not limit the present invention in any form. Technical solutions obtained by equivalent substitution or equivalent variations all fall within the scope of the present invention.

What is claimed is:

1. A method for generating a seed, the method comprising the following steps:
obtaining an algorithm key and generating a target seed algorithm sequence according to the algorithm key and a seed algorithm group;
obtaining inputted seed generation data; and
generating a seed corresponding to the seed generation data by inputting the seed generation data into the target seed algorithm sequence.

2. The method for generating the seed according to claim 1, wherein in the step of generating the target seed algorithm sequence according to the algorithm key and the seed algorithm group, the target seed algorithm sequence is generated according to the algorithm key and a target seed algorithm.

3. The method for generating the seed according to claim 2, wherein the target seed algorithm is a target seed algorithm selected in the seed algorithm group seed selection algorithm on the basis of a current calculation round by adopting a seed selection algorithm.

4. The method for generating the seed according to claim 3, wherein the algorithm key and a corresponding round are directly regarded as or converted after calculation and then regarded as input of the target seed algorithm in a calculation round in which the seed is generated.

5. The method for generating the seed according to claim 1, further comprising storing the algorithm key on the basis of a control instruction of a host computer before obtaining the algorithm key.

6. The method for generating the seed according to claim 1, further comprising the following steps before obtaining the inputted seed generation data:
obtaining a seed generation parameter carried by a seed generation instruction when obtaining the seed generation instruction;
generating a random number according to the seed generation parameter and generating a mnemonic word on the basis of the random number, a mnemonic word dictionary and a mnemonic word generation algorithm;
showing the generated mnemonic word;
obtaining a mnemonic word passphrase inputted by a user according to a seed generation instruction parameter or a seed recovery instruction parameter; and
determining the mnemonic word and the passphrase as the seed generation data

7. The method for generating the seed according to claim 1, further comprising:
obtaining a seed recovery parameter carried by a seed generation instruction or a seed recovery instruction when obtaining the seed generation instruction and the seed recovery instruction;
obtaining a mnemonic word for recovering the seed according to the seed recovery parameter;
obtaining a mnemonic word passphrase inputted by a user according to the seed recovery parameter; and
generating the seed corresponding to the mnemonic word and the mnemonic word passphrase by inputting the mnemonic word and the mnemonic word passphrase into the target seed algorithm sequence.

8. A seed generating device comprising:
a sequence generating module, configured to obtain an algorithm key and generate a target seed algorithm sequence according to the algorithm key and a seed algorithm group;
a data generation obtaining module, configured to obtain inputted seed generation data; and
a seed generating module, configured to generate a seed corresponding to the seed generation data by inputting the seed generation data into the target seed algorithm sequence.

9. The seed generating device according to claim 8, wherein the sequence generating module is configured to generate the target seed algorithm sequence according to the algorithm key and a target seed algorithm.

10. The seed generating device according to claim 9, wherein the target seed algorithm is a target seed algorithm selected in the seed algorithm group seed selection algorithm on the basis of a current calculation round by adopting a seed selection algorithm.

11. The seed generating device according to claim 10, wherein the algorithm key and a corresponding round are directly regarded as or converted after calculation and then regarded as input of the target seed algorithm in a calculation round in which the seed is generated.

12. The seed generating device according to claim 8, further comprising an algorithm key generating module, configured to store the algorithm key on the basis of a control instruction of a host computer.

13. The seed generating device according to claim 8, further comprising:
a parameter obtaining module, configured to obtain a seed generation parameter carried by a seed generation instruction when obtaining the seed generation instruction;
a mnemonic word generating module, configured to generate a random number according to the seed generation parameter and generate and display a mnemonic word according to the random number, a mnemonic word dictionary and a mnemonic word generation algorithm;
a mnemonic word showing module, configured to show the mnemonic word generated by the mnemonic word generating module;
a passphrase obtaining module, configured to obtain an inputted mnemonic word passphrase according to a seed generation instruction parameter or a seed recovery instruction parameter; and
a data determining module, configured to determine the mnemonic word and the mnemonic word passphrase as the seed generation data.

14. The seed generating device according to claim 8, further comprising:
a parameter obtaining module, configured to obtain a seed recovery parameter carried by a seed generation instruction or a seed recovery instruction when obtaining the seed generation instruction and the seed recovery instruction;
a mnemonic word obtaining module, configured to obtain the mnemonic word for recovering the seed according to the seed recovery parameter;
a passphrase obtaining module, configured to obtain the mnemonic word passphrase inputted by a user according to the seed recovery parameter; and
a seed recovery module, configured to generate the seed corresponding to the mnemonic word and the mnemonic word passphrase by inputting the mnemonic word and the mnemonic word passphrase into the target seed algorithm sequence.
